(19) United States
(12) Patent Application Publication
(10) Pub. No.: US 2006/0090388 A1
(43) Pub. Date: May 4, 2006

(54) Integrated line guide seat for fishing rods

(76) Inventor: Tsung-Seng Lee, Tainan City (TW)

Correspondence Address: BIRCH STEWART KOLASCH & BIRCH, PO BOX 747, FALLS CHURCH, VA, 22040-0747, US

(21) Appl. No.: 10/975,414

(22) Filed: Oct. 29, 2004

(51) Int. Cl. A01K 87/04

(52) U.S. Cl. 43/24

(57) ABSTRACT

An integrated line guide seat for fishing rods includes a double-reel line guide seat, a plurality of single-reel line guide seats and a tip reel seat each having a body formed by integrated fabrication. The body has threading holes on the lateral sides for threading a fishing line and circular openings on the front end and the rear end formed by machining. The body further has two fastening sections extended from two sides of the bottom thereof and formed with an arched cross section by machining. As the body is fabricated integrally, thus molding cost may be saved, and unnecessary fabrication processes such as drawing, stamping and bending with molds may be dispensed with.

### FIELD OF THE INVENTION

The present invention relates to an integrated line guide seat for fishing rods to simplify fabrication and reduce molding cost.

### BACKGROUND OF THE INVENTION

Conventional line guide seats mounting on the fishing rod generally are fabricated through a lot of processes (referring to FIG. 1), including: stamping a metal sheet A to form a body B and a left and a right fastening sections C; bending a front side B1 and a rear side B2 of the body B through a mold to form corresponding sides; bending the left and the right fastening sections C through a mold to form a desired curvature; moving the left and the right fastening sections C below the central bottom of the front and rear sides B1 and B2; bending bulged sections B10 and B20 on the bottom of the front and rear sides B1 and B2 inwards towards each other through a mold to position the fastening sections C; finally two sides of a soldering a neck B3 on the top of the front and rear sides B1 and B2. Then couple a line guide reel on the body to finish the line guide seat. The metal sheet A has to go through a number of fabrication processes, including stamping with molds, bending, machining, and grinding. The connecting sections of the line guide seat are spaced in a straight and flat manner. The left and the right fastening sections C thus formed have a limited strength.

While the fabrication of the conventional line guide seat looks simple, the actual production involves mold design and fabrication, and many fabrication processes (stamping, bending, machining). It is costly and not economic effective.

### SUMMARY OF THE INVENTION

Therefore the present invention aims to solve the aforesaid problem occurred to the conventional structure and fabrication process that requires multiple molds. The present invention provides integrated line guide seats that contain double-reel and single-reel and a tip reel seat for fishing rods with minimum molding during fabrication process without comprising other functions and requirements and is mostly integrally formed to reduce fabrication cost.

Through the integrated forming method, the body for a double-reel line guide seat, a signal-reel line guide seat and a tip reel seat are fabricated respectively. Then threading holes are formed on two lateral sides and circular openings are formed on the front end and the rear end of the body by machining, and a left and a right fastening sections with an arched cross section are formed; and a line guide reel is be pivotally coupled on the body. The integrated body and the line guide reel may be coupled rapidly to save molds and reduce fabrication cost.

In order to achieve the foregoing object, the integrated line guide seat for fishing rods according to the invention includes line guide seats that contain double-reel and single-reel and a tip reel seat.

In one aspect, after the line guide seats of the invention have been integrally formed, each is fabricated by machining to form threading holes on two lateral sides and circular openings on the front and rear ends thereof, and two fastening sections on the left and right outer sides of the bottom edge of two sides with an arched cross section.

In another aspect, the double-reel line guide seat of the invention is installed on the butt section of the fishing rod that has two line guide reels arranged in an inclined manner and an integrated body. The body has connecting sections extended downwards and projected slightly outwards from two sides and an arched reinforced member bridging the two connecting sections. The connecting sections are extended to the left side and the right side to form respectively a fastening section. Through machining, the body forms two threading holes on two lateral sides for threading a fishing line and circular openings on the front and the rear ends for holding the line guide reels.

In yet another aspect, the single-reel line guide seats of the invention are installed on the middle portion of the fishing rod and spaced from one another. They have respectively an integrated body of varying heights to pivotally hold a line guide reel. The center of the single-reel line guide seats are located on the finishing rod on a linear fashion. The body has connecting sections extended downwards and projected slightly outwards from two sides and an arched reinforced member bridging the two connecting sections. The connecting sections are extended to the left side and the right side to form respectively a fastening section. Through machining, the body forms two threading holes on two lateral sides for threading the fishing line and circular openings on the front and the rear ends for holding the line guide reel.

In still another aspect, tip reel seat of the invention has an integrated body which has a coupling section extended from the bottom to couple with a tube. Through machining, the body forms two treading holes on two lateral sides and circular openings on the front and the rear ends to hold the line guide reel.

Hence the line guide seats that contain double-reel and single-reel and the tip reel seat according to the invention are formed as desired integrally through the fabrication processes without a lot of molds. The fabrication processes are much simpler and the production cost is lower.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional double-reel line guide seat fabricated by multiple molds through stamping, bending and machining.

FIG. 2 is an exploded view of the configuration of the present invention.

FIG. 3 is a front view of the configuration of the present invention.

FIG. 4 is a perspective view of an integrated forming body prototype of a double-reel line guide seat of the invention.

FIG. 5 is an exploded view of the assembled double-reel line guide seat according to FIG. 4.

FIG. 6 is a perspective view of an integrated forming body prototype of a tip reel seat of the invention.

FIG. 7 is an exploded view of the tip reel seat according to FIG. 6.

FIG. 8 is a perspective view of an integrated forming body prototype of a single-reel line guide seat of the invention.

FIG. 9 is an exploded view of the assembled single-reel line guide seat according to FIG. 8.

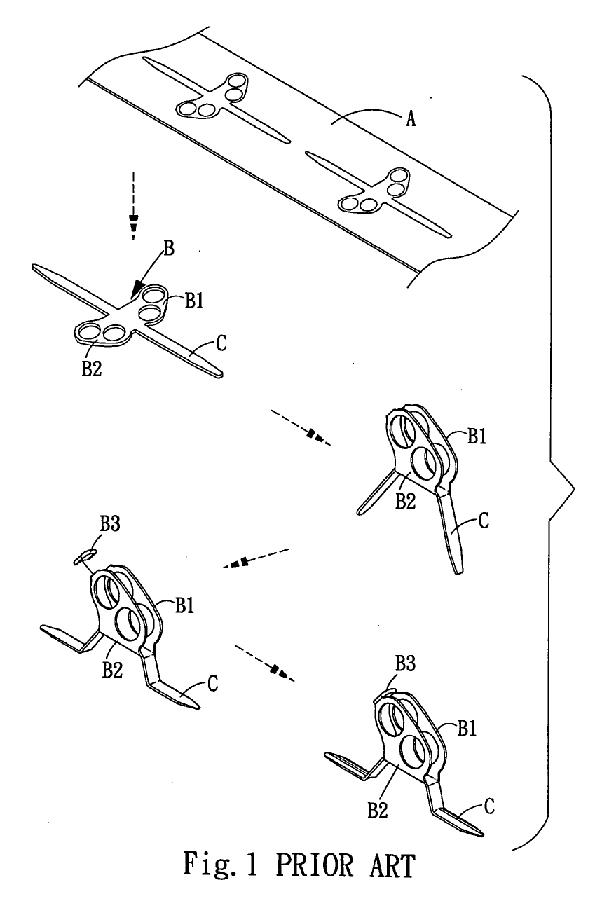

### DETAILED DESCRIPTION OF THE PREFERRED EMBODIMENTS

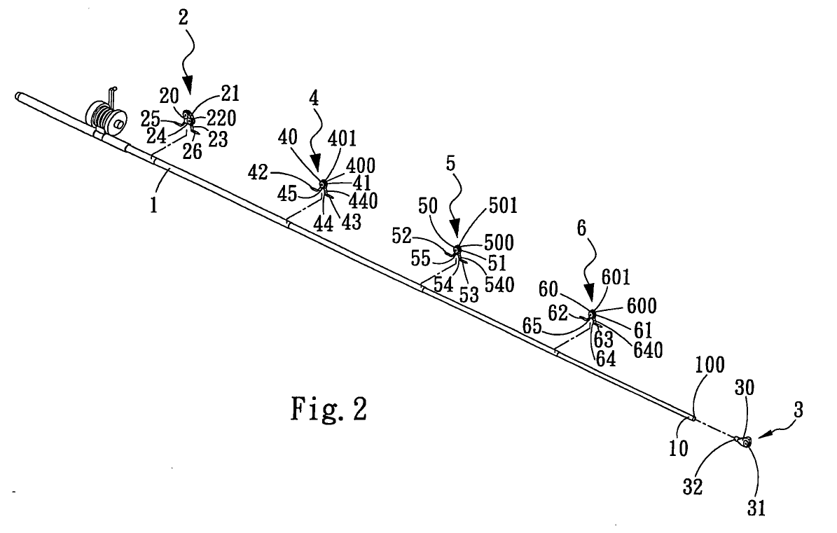

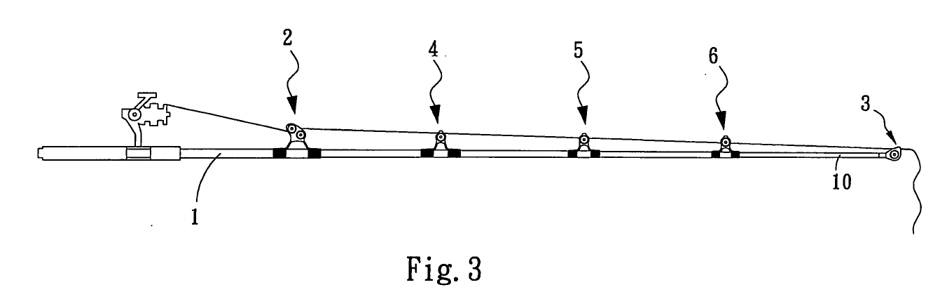

Please refer to FIGS. 2 and 3, the integrated line guide seat for fishing rods according to the invention includes a double-reel line guide seat 2 installed on the butt section of a fishing rod 1, a tip reel seat 3 coupled on the front tip of the fishing rod 1 and a plurality of single-reel line guide seats 4, 5 and 6 located in the middle portion of the fishing rod 1 between the butt section and the front tip and spaced from one another.

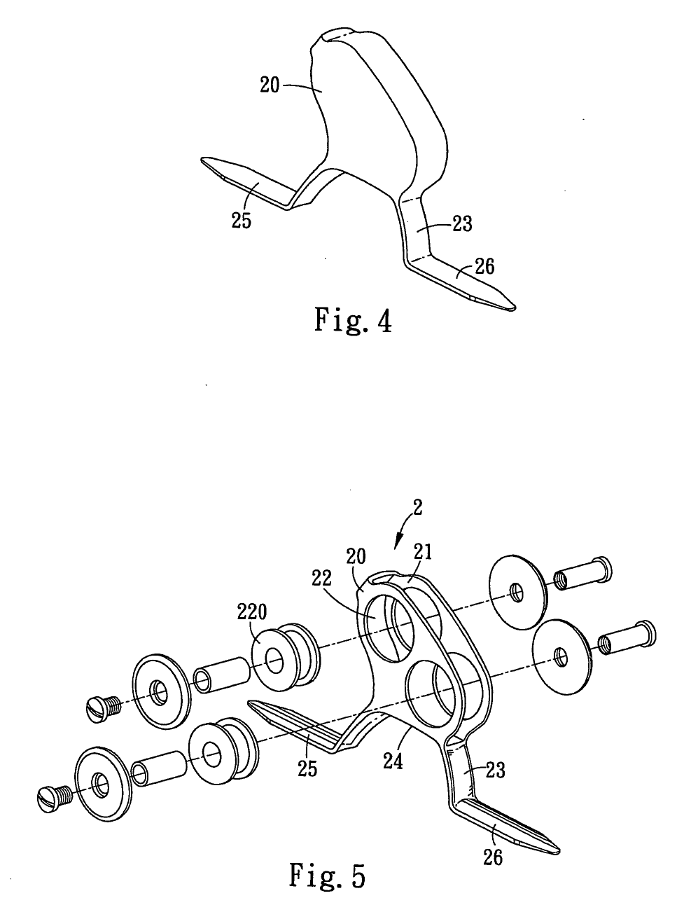

Referring to FIGS. 4 and 5, the double-reel line guide seat 2 includes a body 20 formed integrally. The body 20 has two threading holes 21 on two lateral sides formed by machining, and two circular openings 22 on a front end and a rear end also formed by machining and arranged in an inclined manner. Each circular opening 22 is coupled with a line guide reel 220. The body 20 further has connecting sections 23 with an arched cross section 230 extended downwards and projected slightly outwards from two sides and an arched reinforced member 24 bridging the two connecting sections 23. The connecting sections 23 are extended outwards to a left side and a right side to form respectively a fastening section 25 and 26.

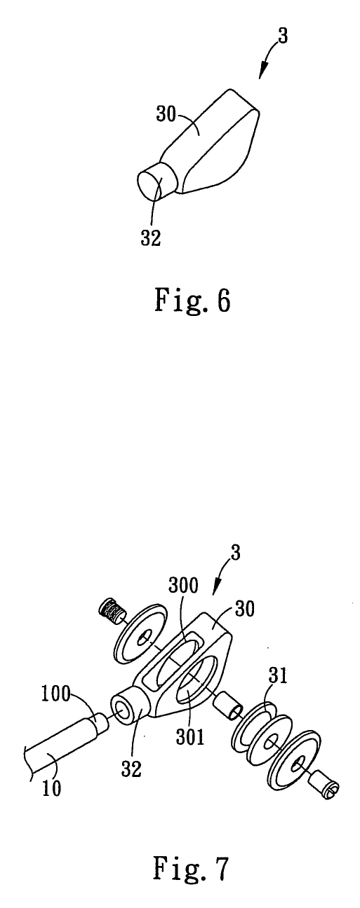

Refer to FIG. 6, the tip reel seat 3 coupled on the front tip of the fishing rod 1 includes a body 30 formed integrally. The body 30 has a coupling section 32 extended from the bottom to couple with a tenon 100 extended from one side of the blade 10 of the fishing rod 1. Through machining, the body 30 has two treading holes 300 on two lateral sides and circular openings 301 on the front and the rear ends to pivotally hold a line guide reel 31 (referring to FIG. 7).

The single-reel line guide seats 4, 5 and 6 located in the middle portion have same structure. They are pivotally coupled with a line guide reel 41, 51 and 61 that are aligned linearly, and have respectively a body 40, 50 and 60 and the line guide reels 41, 51 and 61 (as shown in FIGS. 2, 8 and 9).

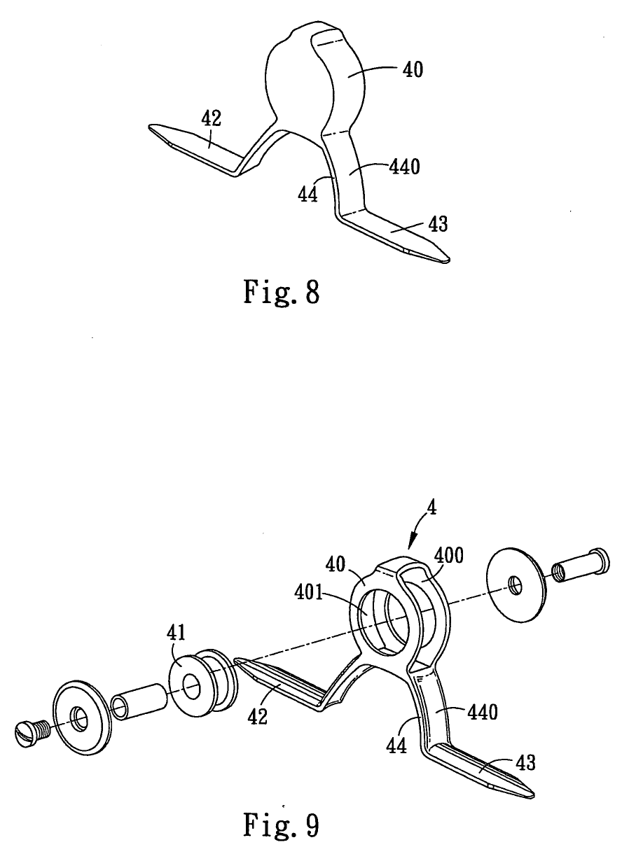

The body 40 (referring to FIG. 8), 50 and 60 have respectively threading holes 400, 500 and 600 on two lateral sides, and circular openings 401, 501 and 601 on two ends formed by machining. The circular openings 401, 501 and 601 are pivotally coupled respectively with the line guide reels 41, 51 and 61. The body 40, 50 and 60 have respectively two sides extended to form fastening sections 42, 43, 52, 53, 62 and 63 that have an arched cross section formed by machining (referring to FIG. 9). The body 40, 50 and 60 further have respectively connecting sections 44, 54 and 64 on two sides with an arched cross section 440, 540 and 640, and an arched reinforced member 45, 55 and 65 bridging the two connecting sections 44, 54 and 64.

Referring to FIG. 2, the double-reel line guide seat 2 is installed on the butt section of the fishing rod 1, the tip reel guide 3 is coupled on the front tip of the fishing rod 1, and the single-reel line guide seats 4, 5 and 6 are installed on the middle portion of the fishing rod 1 in a spaced manner. The fastening sections 25, 26, 42, 43, 52, 53, 62 and 63 are fastened to the fishing rod 1 through a fastening line 7. Thus when the fishing rod 1 is swung or withdrawn during fishing, the fishing line 8 may be held steadily by the double-reel and single-reel line guide seats 2, 4, 5 and 6 that are fastened to the fishing rod 1 through the connecting sections 23, 44, 54 and 64 on two sides each having an arched cross section 230, 440, 540 and 640, and a reinforced member 24, 45, 55 and 65 bridged therebetween, Hence the problem of swaying and unsteady fishing line 8 caused by external forces that could affect fish catching occurred to the conventional fishing rods may be prevented. In addition, the double-reel and single-reel line guide seats 2, 4, 5 and 6 of the invention are fabricated integrally and can save the cost of molds fabrication.

What is claimed is:

1. An integrated line guide seat for fishing rods, comprising a double-reel line guide seat mounted on a butt section of a fishing rod, a tip reel seat coupled on a front tip of the fishing rod, and a plurality of single-reel line guide seats mounted in the middle of the fishing rod between the butt section and the front tip and spaced from one another;
wherein the double-reel line guide seat, the single-reel line guide seats and the tip reel seat have respectively a body formed integrally, the body having connecting sections extended downwards and outwards from two sides that are further extended to a left side and a right side to form respectively a fastening section.
